(19) United States
(12) Patent Application Publication
(10) Pub. No.: US 2009/0104948 A1
(43) Pub. Date: Apr. 23, 2009

(54) HANDHELD ELECTRONIC DEVICE

(75) Inventors: Alex Cheng, Shanghai City (CN); Shen Zhang, Shanghai City (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INVENTEC APPLIANCES CORP., Taipei (TW)

(21) Appl. No.: 12/255,674

(22) Filed: Oct. 22, 2008

(30) Foreign Application Priority Data
Oct. 23, 2007 (TW) 96139708

(51) Int. Cl. H04M 1/00

(52) U.S. Cl. 455/575.1

(57) ABSTRACT

A handheld electronic device including a body, a cover, a locking structure, and a button structure is provided. The body has a cave, and the cover has a first locking part. The cover is adapted to be slidably disposed on the body and cover the cave. The locking structure has a first fastened end and a first cantilever. The first fastened end is fastened to the inner wall of the body, and a second locking part corresponding to the first locking part is disposed on the first cantilever. The button structure is corresponding to the locking structure. When the second locking part locks with the first locking part, the button structure is used to apply a force to the locking structure, to elastically deform the first cantilever for unlocking the second locking part and the first locking part.

### CROSS-REFERENCE TO RELATED APPLICATION

This application claims the priority benefit of Taiwan application serial no. 96139708, filed on Oct. 23, 2007. The entirety of the above-mentioned patent application is hereby incorporated by reference herein and made a part of specification.

### BACKGROUND OF THE INVENTION

1. Field of the Invention

The present invention generally relates to an electronic device, in particular, to a handheld electronic device.

2. Description of Related Art

In the recent information society, people have an increasing dependence on electronic products. Mobile phones, handheld PCs, personal digital assistances (PDAs) can be commonly seen in our daily life. Electronic products have become indispensable in daily life, and new electronic products with humanized and preferable functions are continuously brought up. For example, along with the improved manufacturing technique and reduced cost, the possessing rate of mobile phone is growing quickly, so that the mobile phone has become the most common communication tool nowadays, and is almost possessed by every single person. Therefore, in addition to providing more convenience for users to use the mobile phones or providing more functions on the mobile phone, the maintenance of the appearance of the mobile phones has become a significant object in the research and development of mobile phones for the manufacturers.

In the conventional mobile phone, the battery cover is usually provided with a hook, and the body is provided with a slot, and the hook of the battery cover is corresponding to the slot of the body. When assembling the battery cover onto the body and disassembling the battery cover from the body, the hook of the battery cover may easily have friction with the body around the slot, so as to cause a defect in the appearance of the body. In particular, a more obvious abrasion between the battery cover made of metal material and the body made of plastic material may occur due to the different hardness of the materials. Thereby, not mentioning the defects in appearance, the abrasion may possibly cause loosening and falling of the battery cover, so as to affect the lifetime in usage.

### SUMMARY OF THE INVENTION

Accordingly, the present invention is directed to a handheld electronic device, for alleviating the abrasion when locking the cover and the body.

The present invention provides a handheld electronic device, which includes a body, a cover, a locking structure, and a button structure. The body has a cave and a penetration hole connecting to each other. The cover has a first locking part. The cover is adapted to be slidably disposed on the body along a first path and cover the cave, so as to form an accommodating space. The locking structure has a first fastened end and a first cantilever. The first fastened end is fastened to the inner wall of the body, and the first cantilever is provided with a second locking part. The second locking part is used to lock with the first locking part, for limiting the displacement of the cover slidably disposed on the body. The button structure penetrates the penetration hole, and corresponds to the locking structure. When the second locking part locks with the first locking part, the button structure is used to apply a force to the locking structure along a second path, to elastically deform the first cantilever for unlocking the second locking part and the first locking part.

In an embodiment of the present invention, the first locking part includes a hook, and the second locking part includes a slot.

In an embodiment of the present invention, the first locking part includes a slot, and the second locking part includes a hook.

In an embodiment of the present invention, the button structure includes a second fastened end and a second cantilever. The second fastened end is fastened to the inner wall of the body, and the second cantilever is provided with a push part. The push part penetrates the penetration hole, and is used by being pushed to elastically deform the first cantilever along the second path, so as to unlock the second locking part and the first locking part.

In an embodiment of the present invention, the first cantilever is farther provided with a guiding part, and the guiding part is located on the first path and adapted to guide the first locking part to lock with the second locking part.

In an embodiment of the present invention, the first cantilever extends out from the first fastened end to the cave.

In an embodiment of the present invention, the first path is perpendicular to the second path.

In the present invention, since the locking structure with one suspending end is disposed inside the body, when the user intends to assemble the cover, e.g., a battery cover, to the body or disassemble the cover from the body, the body is not susceptible to being abraded by the cover. In other words, the handheld electronic device provided in the present invention has a shape more secure from abrasion.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic assembled view of a handheld electronic device according to an embodiment of the present invention.

FIG. 2 is an exploded view of the handheld electronic device in FIG. 1 seen from another angle of view.

FIGS. 3A to 3C show a cross sectional view of a flow chart of disassembling a cover in FIG. 1 from a body.

FIGS. 4A to 4D show a cross sectional view of a flow chart of assembling the cover in FIG. 1 onto the body.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

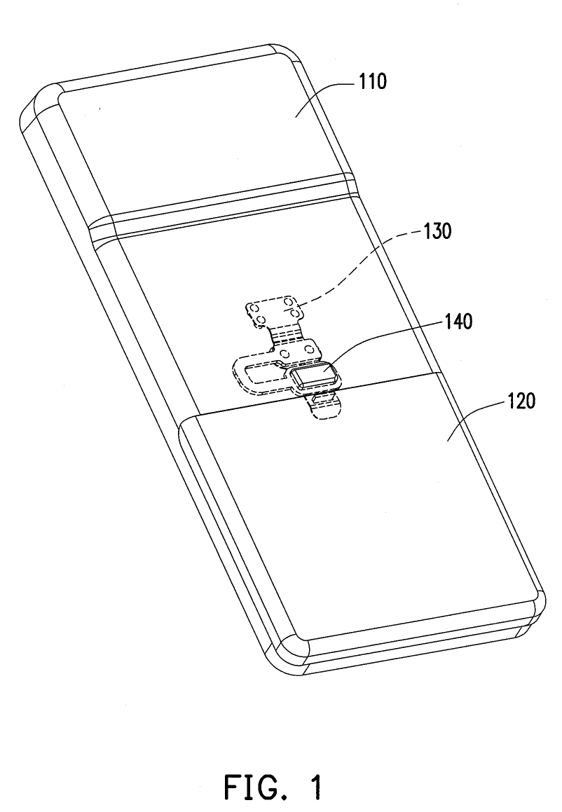

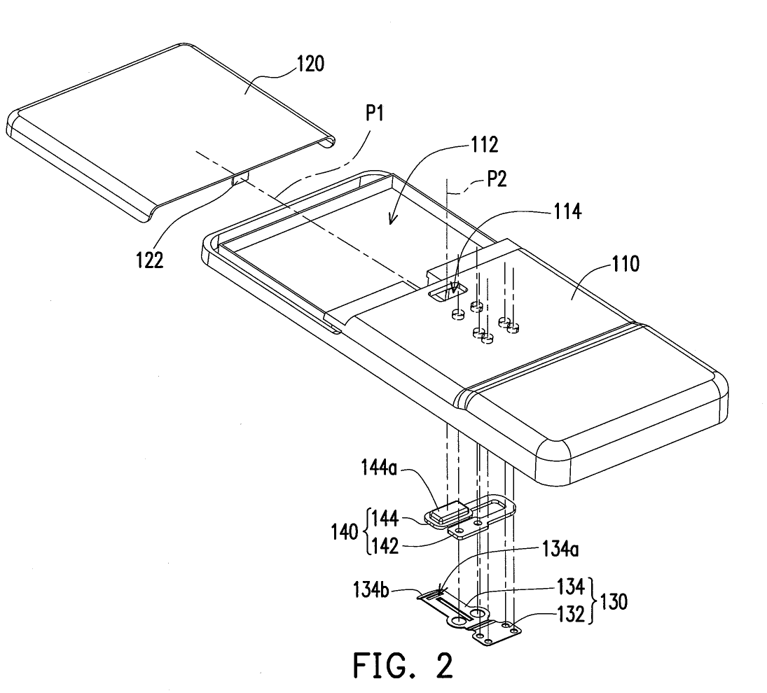

FIG. 1 is a schematic assembled view of a handheld electronic device according to an embodiment of the present invention, and FIG. 2 is an exploded view of the handheld electronic device in FIG. 1 seen from another angle of view. Referring to FIGS. 1 and 2, the handheld electronic device 100 includes a body 110, a cover 120, a locking structure 130, and a button structure 140 corresponding to the locking structure 130. The body 110 has a cave 112 and a penetration hole 114 connecting to each other. The cover 120 has a first locking part 122. The cover 120 is adapted to be slidably disposed on the body 110 along a first path P1, and cover the cave 112 to form an accommodating space. In this embodiment, the handheld electronic device 100 takes a mobile phone as an example, the cave 112 is used to accommodate a battery (not shown) of the mobile phone, and the cover 120 is, for example, a battery cover of the mobile phone.

In this embodiment, the locking structure 130 is, for example, a metal piece having a first fastened end 132 and a first cantilever 134. The first fastened end 132 is fastened to the inner wall of the body 110 in the manner of hot melt, and the first cantilever 134 extends out from the first fastened end 132 to the cave 112. The first cantilever 134 is provided with a second locking part 134a. The first locking part 122 including a hook is used to lock with the second locking part 134a including a slot. Moreover, the first cantilever 134 may be further provided with a guiding part 134b. The guiding part 134b is located on the first path P1 and adapted to guide the first locking part 122 to lock with the second locking part 134a.

In addition, the button structure 140 corresponding to the locking structure 130 penetrates the penetration hole 114. The button structure 140 includes a second fastened end 142 and a second cantilever 144. The second fastened end 142 may also be fastened to the inner wall of the body 110 in the manner of hot melt. In this embodiment, the second cantilever 144 is provided with a push part 144a, which penetrates the penetration hole 114 along a second path P2 perpendicular to the first path P1.

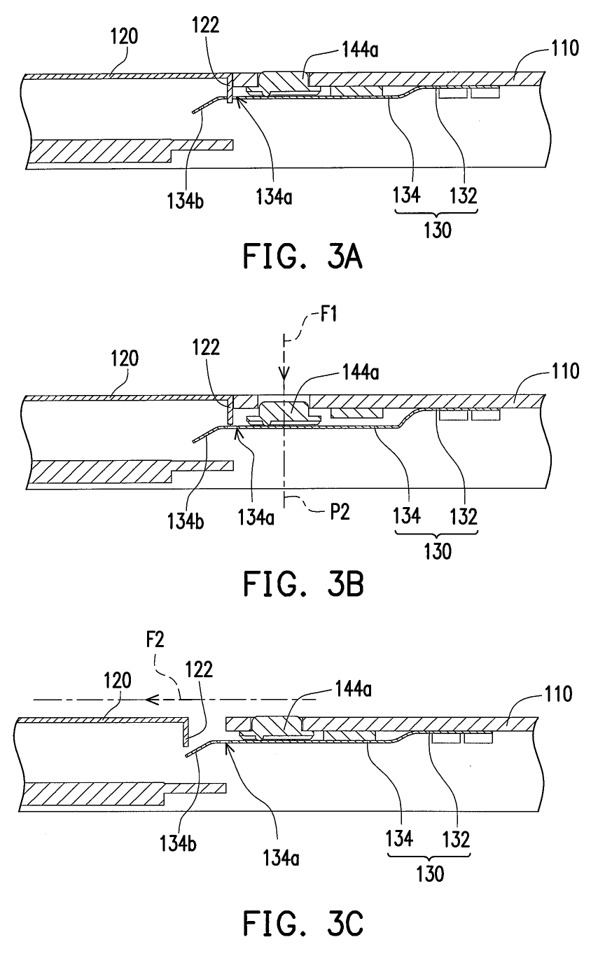

FIGS. 3A to 3C show a cross sectional view of a flow chart of disassembling a cover in FIG. 1 from a body. Firstly, referring to FIG. 3A, when the cover 120 is assembled to the body 110, the second locking part 134a on the first cantilever 134 may lock with the first locking part 122 of the cover 120. Then, referring to FIG. 3B, when the user intends to disassemble the cover 120 from the body 110, the user may apply a force F1 to the push part 144a along the second path P2 to elastically deform the first cantilever 134 with the first fastened end 132 as a pivot, and thereby, the second locking part 134a of the first cantilever 134 may unlock from the first locking part 122. After that, referring to FIG. 3C, when the second locking part 134a unlocks from the first locking part 122, the user may apply a force F2 to the cover 120 along the first path P1, so that the cover 120 is disassembled from the body 110.

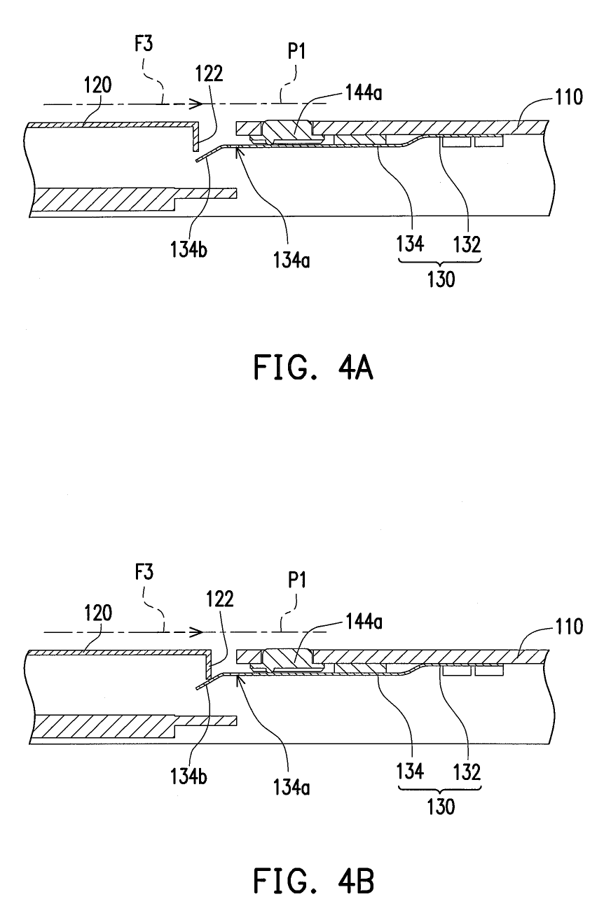

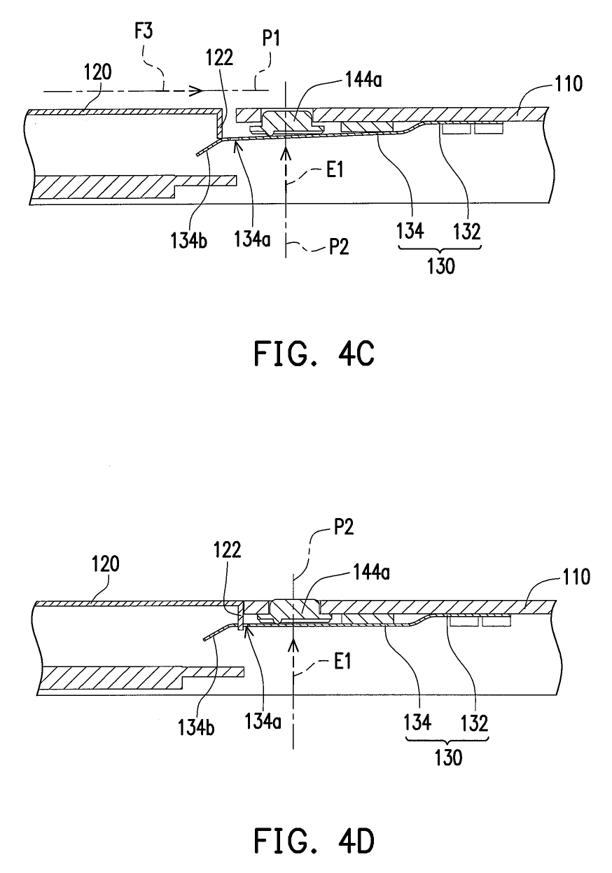

FIGS. 4A to 4D show a cross sectional view of a flow chart of assembling the cover in FIG. 1 onto the body. Firstly, referring to FIGS. 4A and 4B, when the user intends to assemble the cover 120 onto the body 110, the user may apply a force F3 on the cover 120 (the force F3 has an opposite direction to the force F2 in FIG. 3B) along the first path P1. Since the guiding part 134b disposed on the first cantilever 134 is on the first path P1, when the cover 120 moves along the first path P1, the first locking part 122 of the cover 120 may abut with the guiding part 134b. After that, referring to FIGS. 4C to 4D, when the cover 120 continues to move along the first path P1, the consistent action between the first locking part 122 and guiding part 134b may drive the first cantilever 134 to elastically deform with the first fastened end 132 as a pivot (as shown in FIG. 4C). When the first locking part 122 including the hook moves along the first path P1 to the accommodating position of the second locking part 134a including the slot, the first locking part 122 no longer applies a force on the first cantilever 134, the first cantilever 134 may recover to the initial position under an elastic force E1, and the first locking part 122 may lock with the second locking part 134a (as shown in FIG. 4D). The locking state between the first locking part 122 and the second locking part 134a effectively limits the displacement of the cover 120. Thereby, the cover 120 is stably assembled on the body 110.

Based on the above, in the present invention, since the locking structure with one suspending end is disposed in the body, when the user intends to assemble the cover such as a battery cover onto the body or disassemble the cover from the body, the abrasion between the locking part of the cover and the locking structure may not easily occur. Furthermore, since the locking structure in the present invention has a guiding part, e.g., a guiding slope, the present invention may effectively alleviate the friction between the cover and the locking structure, and the handheld electronic device of the present invention has a shape more secure from friction or abrasion. In another aspect, abrasion between the body and the cover may not easily occur during the process of assembling the cover onto the body or disassembling the cover from the body, and thus the cover or the body may be made of metal materials with a high hardness. Due to the light and thin characteristics of the metal materials, the handheld electronic device may better meet the requirements on the light and thin trend currently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A handheld electronic device, comprising:
a body, comprising a cave and a penetration hole connecting to each other;
a cover, comprising a first locking part, wherein the cover is adapted to be slidably disposed on the body along a first path and cover the cave so as to form an accommodating space;
a locking structure, comprising a first fastened end and a first cantilever, wherein the first fastened end is fastened to an inner wall of the body, and the first cantilever is provided with a second locking part used to lock with the first locking part for limiting a displacement of the cover; and
a button structure, penetrating the penetration hole and corresponding to the locking structure, wherein when the second locking part locks with the first locking part, the button structure is used to apply a force to the locking structure along a second path to elastically deform the first cantilever for unlocking the second locking part and the first locking part.

2. The handheld electronic device according to claim 1, wherein the first locking part comprises a hook, and the second locking part comprises a slot.

3. The handheld electronic device according to claim 1, wherein the first locking part comprises a slot, and the second locking part comprises a hook.

4. The handheld electronic device according to claim 1, wherein the button structure comprises a second fastened end and a second cantilever, the second fastened end is fastened to the inner wall of the body, the second cantilever is provided with a push part, and the push part penetrates the penetration hole and is used by being pushed to elastically deform the first cantilever along the second path, so as to unlock the second locking part and the first locking part.

5. The handheld electronic device according to claim 1, wherein the first cantilever is further provided with a guiding part, and the guiding part is located on the first path and adapted to guide the first locking part to lock with the second locking part.

6. The handheld electronic device according to claim 1, wherein the first cantilever extends out from the first fastened end to the cave.

7. The handheld electronic device according to claim 1, wherein the first path is perpendicular to the second path.
